(19) United States
(12) Patent Application Publication
(10) Pub. No.: US 2010/0089262 A1
(43) Pub. Date: Apr. 15, 2010

(54) METHOD OF PRINTING FINE PATTERNS BY INTAGLIO PRINTING AND PRINTING SYSTEM FOR PRINTING FINE PATTERNS BY INTAGLIO PRINTING

(76) Inventors: Jie-Hyun Seong, Daejeon (KR); Yang-Gu Kang, Daejeon (KR); Seung-Heon Lee, Seoul (KR); Kyoung-Su Jeon, Seoul (KR); Soon-Yeel Lee, Daejeon (KR); Hye-Jeong Lee, Gyeonggi-do (KR)

Correspondence Address: MCKENNA LONG & ALDRIDGE LLP, 1900 K STREET, NW, WASHINGTON, DC, 20006, US

(21) Appl. No.: 12/449,897

(22) PCT Filed: Mar. 7, 2008
(86) PCT No.: PCT/KR2008/001299

§ 371 Date: Sep. 2, 2009

(30) Foreign Application Priority Data
Mar. 9, 2007 (KR) 10-2007-0023695

(51) Int. Cl. B41F 3/36; B41M 1/10

(52) U.S. Cl. 101/158; 101/170

(57) ABSTRACT

A method of printing fine patterns prints a fine pattern on a substrate using an elastic mold with an intaglio pattern. This method includes applying a fine pattern printing ink to a surface of a patterned elastic mold; removing the ink applied to an embossed portion of the elastic mold by closely adhering an ink removing unit having a polymer resin or an organic compound with a surface energy from <a surface energy of the ink−2 erg/cm²> to <the surface energy of the ink+erg/cm> to the surface of the elastic mold and then detaching the ink removing unit therefrom; and closely adhering the elastic mold to a substrate to transcribe the printing ink thereto. This method allows forming a fine pattern with good quality since the ink applied to the embossed portion of the elastic mold may be effectively removed during a gravure process.

### TECHNICAL FIELD

The present invention relates to a method of printing fine patterns, a printing system of fine patterns, and an ink removing method applied thereto. More particularly, the present invention relates to a method of printing fine patterns, a printing system of fine patterns, which allow forming a fine pattern with high quality by effectively removing an ink applied to an embossed portion of a printing roller during a gravure process, and an ink removing method applied thereto.

### BACKGROUND ART

A gravure process for forming fine patterns is conducted in a way that a material (hereinafter, referred to as an ‘ink’) to be patterned on an intaglio mold is applied, then residual materials existing on an embossed portion are removed using a knife such as a doctor blade, and then a pattern is printed on a substrate.

A conventional intaglio mold used for the gravure process was a hard mold made of steel material or the like, but an elastic mold allowing easy manufacture and replacement was recently frequently used instead of the hard mold. FIG. 1 is a schematic diagram showing a gravure process using an elastic mold. Hereinafter, the gravure process using an elastic mold is explained with reference to FIG. 1. First, an ink 115 used for forming a pattern is applied to a surface of an elastic mold 111 on which an intaglio pattern is formed through an ink supplying unit 113. In this way, the ink 115 is applied not only to an intagliated portion of the elastic mold 111 but also to an embossed portion, so the ink 115 applied to the embossed portion is removed using a removing roller 117 or the like. At this time, if the ink 115 remains on the embossed portion, it is difficult to form a good pattern, so the ink should be entirely removed without any residue. After that, the elastic mold 111 of which the intagliated portion is filled with the ink 115 is closely adhered to a substrate with pressure and then detached from the elastic mold 111. And then, only the ink 115 remains on the substrate 119, which forms a pattern.

In the gravure process using an elastic mold, if a knife such as a doctor blade, commonly used for ink removal conventionally, is used, the ink in the intagliated portion may also be removed together due to the elasticity of the elastic mold. In order to solve this problem, there are used several methods such as rubbing with a soft cloth, a polymer slab or a brush, but it is difficult to remove ink uniformly over a large area reproducibly.

Thus, there have been persistent endeavors in the art to effectively remove an ink applied to an embossed portion of a printing roller during the gravure process, and the present invention is designed under such circumstances.

### DISCLOSURE OF INVENTION

### Technical Problem

The present invention is directed to providing a method of printing fine patterns, which allows effective removal of an ink applied to an embossed portion of a printing roller during a gravure process and particularly enables to effectively remove only an ink applied to the embossed portion without removing an ink filled in an intagliated portion during a gravure process using an elastic mold, thereby ensuring formation of fine patterns with good quality.

The present invention is also directed to providing a printing system of fine patterns, which adopts the above method of printing fine patterns.

### Technical Solution

In order to accomplish the above object, the present invention provides a method of printing fine patterns, which prints a fine pattern on a substrate using an elastic mold with an intaglio pattern, the method comprising: applying a fine pattern printing ink to a surface of a patterned elastic mold; removing the ink applied to an embossed portion of the elastic mold by closely adhering an ink removing unit having a polymer resin or an organic compound with a surface energy ranging from <a surface energy of the ink−2 erg/cm²> to <the surface energy of the ink+8 erg/cm²> to the surface of the elastic mold coated with the printing ink and then detaching the ink removing unit from the surface of the elastic mold; and closely adhering the elastic mold to a substrate to transcribe the printing ink to the substrate.

In another aspect of the present invention, there is also provided a printing system of fine patterns, comprising: a printing roller having an outer circumference with an intaglio pattern and coating a substrate with a fine pattern printing ink filled in an intagliated portion of the outer circumference while rotating on a central axis; an ink supplying unit for supplying and applying the ink to the outer circumference of the printing roller; an ink removing belt rotating in close contact with an embossed portion of the outer circumference of the printing roller so as to remove an ink applied to the embossed portion of the outer circumference of the printing roller and having a polymer resin or an organic compound with a surface energy ranging from <a surface energy of the ink−2 erg/cm²> to <the surface energy of the ink+8 erg/cm²>; and a belt rotating unit for successively rotating the ink removing belt.

In still another aspect of the present invention, there is also provided a printing system of fine patterns, comprising: a printing roller having an outer circumference with an intaglio pattern and coating a substrate with a fine pattern printing ink filled in an intagliated portion while rotating on a central axis; an ink supplying unit for supplying and applying the ink to the outer circumference of the printing roller; and an ink removing roller rotating in close contact with an embossed portion of the outer circumference of the printing roller so as to remove an ink applied to the embossed portion of the outer circumference of the printing roller and having a polymer resin or an organic compound with a surface energy ranging from <a surface energy of the ink−2 erg/cm²> to <the surface energy of the ink+8 erg/cm²>.

### BRIEF DESCRIPTION OF THE DRAWINGS

Other objects and aspects of the present invention will become apparent from the following description of embodiments with reference to the accompanying drawing in which:

FIG. 1 is a schematic diagram showing a gravure process using an elastic mold;

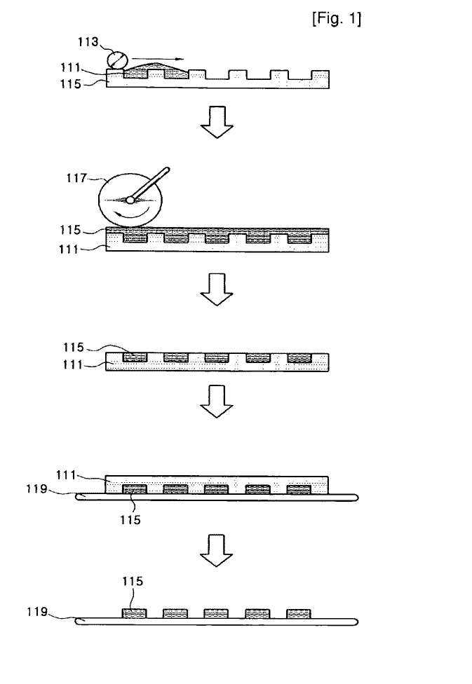

FIG. 2 is a schematic view showing a printing system of fine patterns according to one embodiment of the present invention;

FIG. 3 is a schematic view showing a printing system of fine patterns according to another embodiment of the present invention; and

FIGS. 4 to 8 are photographs showing fine patterns according to embodiments 1 to 3 and comparative examples 1 and 2, respectively.

### BEST MODE FOR CARRYING OUT THE INVENTION

Hereinafter, preferred embodiments of the present invention will be described in detail with reference to the accompanying drawings.

A method of printing fine patterns according to the present invention is used for printing a fine pattern on a substrate using an elastic mold with an intaglio pattern. The method includes the steps of: applying a fine pattern printing ink to a surface of a patterned elastic mold; removing the ink applied to an embossed portion of the elastic mold by closely adhering an ink removing unit having a polymer resin or an organic compound with a surface energy ranging from <a surface energy of the ink−2 erg/cm²> to <the surface energy of the ink+8 erg/cm²> to the surface of the elastic mold coated with the printing ink and then detaching the ink removing unit from the surface of the elastic mold; and closely adhering the elastic mold to a substrate to transcribe the printing ink to the substrate.

The method of printing fine patterns according to the present invention allows effective removal of an ink applied to a surface of the elastic mold before a printing ink is applied to a substrate in the gravure process, thereby capable of improving a printing quality. The method of printing fine patterns according to the present invention removes the ink applied to an embossed portion of the elastic mold by closely adhering a material having a surface energy similar to that of the printing ink, preferably an ink removing unit having a polymer resin or an organic compound with a surface energy ranging from <a surface energy of the ink−2 erg/cm²> to <the surface energy of the ink+8 erg/cm²> to the embossed portion of the elastic mold coated with an intaglio pattern for gravure and then detaching the ink removing unit therefrom. If the surface energy is out of the above range, it is impossible to give a sufficient ink removing effect, disadvantageously.

Work of adhesion (Wₐ) and work of cohesion (W_{c}) are terms representing the tendency for two materials to keep their adhesion or cohesion state. If the above value is great, it means two materials show a great tendency to keep their adhesion or cohesion state. The work of adhesion is used when two materials are different from each other, and the work of cohesion is used when two materials are identical to each other. However, the work of adhesion is affected by a surface energy of each material, and if surface energies of two materials are similar, the tendency of keeping an adhesion state is increased to show a greater work of adhesion. Meanwhile, when an ink is removed from the elastic mold, only the ink on the embossed portion should be selectively removed, since the ink in the intagliated portion should be transcribed to the substrate. In addition, since the ink lumps in the intagliated portion of the elastic mold, the ink in the intagliated portion is more influenced by its work of cohesion than the ink on the embossed portion. Thus, if the surface energy of the ink removing unit is set similar to the surface energy of the ink, it is possible to remove the ink on the embossed portion less influenced by the work of cohesion but to let the ink in the intagliated portion greatly influenced by the work of cohesion remain on the elastic mold.

The material of the elastic mold used for forming fine patterns is representatively a silicon elastomer, but not limitedly. The above ink removing method may be used to all kinds of materials used in forming fine patterns without limitation. An ink generally used for forming fine patterns has a surface energy ranging from 20 to 45 erg/cm². Thus, the ink removing unit is prepared using a polymer resin or an organic compound with a surface energy ranging from 18 to 53 erg/cm² in consideration of the surface energy of the ink. In case an elastic mold made of silicon elastomer is used, the ink preferably has a surface energy ranging from 25 to 30 erg/cm², and at this time the ink removing unit is prepared using a polymer resin or an organic compound with a surface energy ranging from 23 to 38 erg/cm² in consideration of the surface energy of the ink. The polymer resin with such a surface energy may be LDPE (low density polyethylene), polypropylene, or polybutylmethacrylate. These polymer resins have surface energies of 34.5 erg/cm², 31.9 erg/cm², and 31.2 erg/cm², respectively. These polymer resins may be used in single or in mixture, and if required, these polymer resins may be used as being attached to a support such as metal, carbon, plastic and ceramic, which is processed into a film, sheet or roll shape. The organic compound is preferably used as a coating on a support such as metal, carbon, plastic and ceramic, which is processed into a film, sheet or roll shape, due to its features. The organic compound with the above surface energy is representatively diphenyldichlorosilane.

The method of printing fine patterns according to the present invention may be used for all kinds of gravure processes, but it is more effectively used for a gravure process using an elastic mold, namely using a printing roller having a body and an elastic mold with an intaglio pattern. If the method of printing fine patterns according to the present invention is applied to the gravure process using an elastic mold, it is possible to effectively remove only an ink applied to an embossed portion without removing an ink filled in an intagliated portion.

The present invention also provides a printing system of fine patterns, which may be utilized for the above method of printing fine patterns.

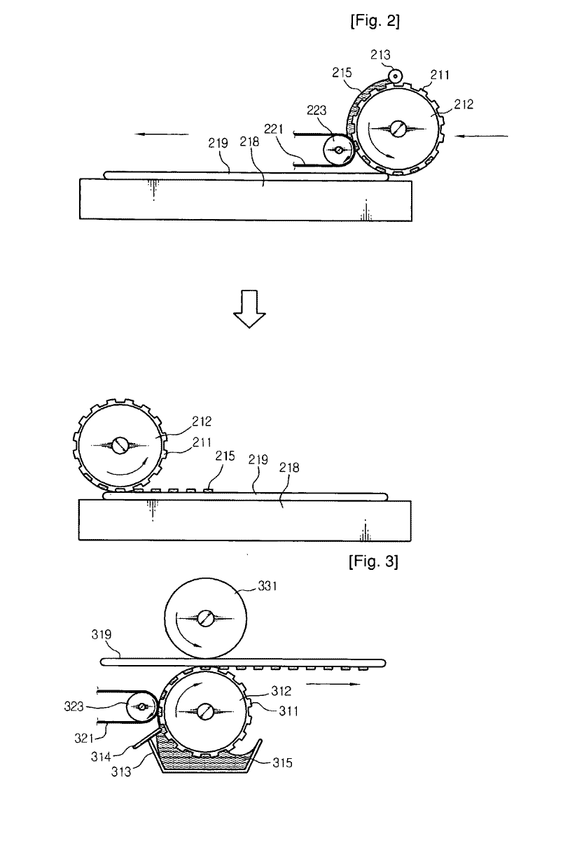

FIG. 2 is a schematic view showing a printing system of fine patterns according to one embodiment of the present invention. Referring to FIG. 2, the printing system of fine patterns according to one embodiment of the present invention includes a printing roller 211, 212 having an outer circumference with an intaglio pattern and coating a substrate with a fine pattern printing ink 215 applied to an intagliated portion while rotating on a central axis; an ink supplying unit 213 for supplying and applying the fine pattern printing ink 215 to the outer circumference of the printing roller 211, 212; an ink removing belt 221 rotating in close contact with an embossed portion of the outer circumference of the printing roller 211, 212 so as to remove an ink applied to the embossed portion of the outer circumference of the printing roller 211, 212 and having a polymer resin or an organic compound with a surface energy ranging from <a surface energy of the ink−2 erg/cm²> to <the surface energy of the ink+8 erg/cm²>; and a belt rotating unit 223 for successively rotating the ink removing belt 221.

In the above printing system of fine patterns, the printing roller 211, 212 carries the substrate while rotating in close contact with an upper portion of the substrate, thereby transcribing the printing ink 215 onto the substrate. The printing roller 211, 212 may be composed of a body 212 and an elastic mold 211 as shown in the figure, and it may also be configured such that a pattern is formed in an outer circumference of the body 212 made of a single material. At this time, the ink supplying unit 213 supplies and applies the fine pattern printing ink 215 to the outer circumference of the printing roller 211, 212, and the printing roller 211, 212 is successively coated with the ink on its entire outer circumference while rotating in an arrow direction. The ink removing belt 221 successively removes the ink 215 applied to the embossed portion of the outer circumference of the printing roller 211, 212 before the ink 215 applied to the printing roller 211, 212 is applied to the substrate. The ink removing belt 221 is mainly made of a polymer resin or an organic compound with a surface energy ranging from <a surface energy of the ink−2 erg/cm²> to <the surface energy of the ink+8 erg/cm²> as mentioned above, so it shows an excellent ink removing effect. If the ink 215 on the embossed portion of the outer circumference of the printing roller 211, 212 is removed, the ink 215 filled in the intagliated portion of the outer circumference of the printing roller 211, 212 is applied onto the substrate. The belt rotating unit 223 is installed to the printing system of fine patterns for the purpose of successive rotation of the ink removing belt, and the substrate 219 may be fixed on a support 218 so as to prevent shaking.

In this embodiment, the ink removing belt 221 is used as the ink removing unit, and the belt rotating unit 223 is used for rotating the ink removing belt 221, but it is also possible that an ink removing roller is used as the ink removing unit instead of the ink removing belt 221 and the belt rotating unit 223. This ink removing roller rotates in close contact with the embossed portion of the printing roller and thus removes an ink supplied from the ink supplying unit and applied to the embossed portion of the outer circumference of the printing roller. This ink removing roller has an outer circumference made of a polymer resin or an organic compound with a surface energy ranging from <a surface energy of the ink−2 erg/cm²> to <the surface energy of the ink+8 erg/cm²>, so it gives an excellent ink removing effect.

The printing system of fine patterns according to the present invention may further include a holding roller, and the holding roller plays a role of holding and carrying a substrate together with the printing roller in case the substrate has a film shape. Also, the printing system of fine patterns according to the present invention may further include a drying device for drying the ink applied onto the substrate.

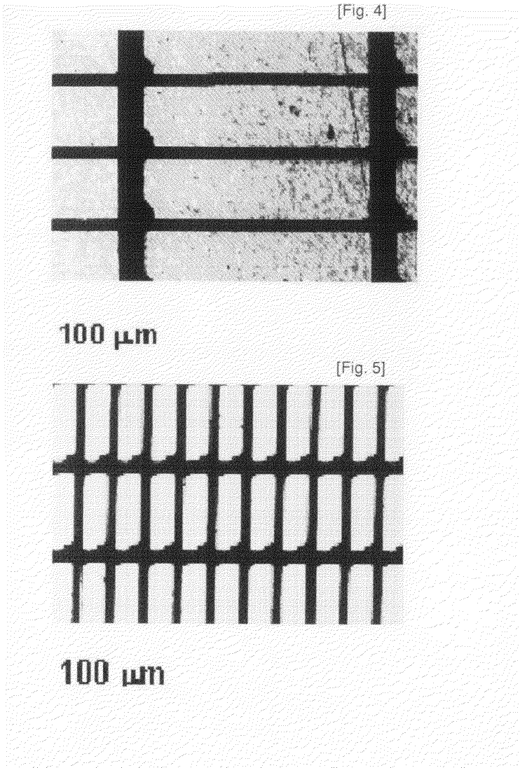

FIG. 3 is a schematic view showing a printing system of fine patterns according to another embodiment of the present invention. In the printing system of fine patterns according to this embodiment, while a film-type substrate 319 passes between a holding roller 331 and a printing roller 311, 312, an ink 315 filled in an intagliated portion of an elastic mold 311 fixed to a body 312 of the printing roller is applied onto a substrate. At this time, while the printing roller 311, 312 and the holding roller 331 keep rotating, the ink 315 is successively printed on a surface of the substrate 319. The printing roller 311, 312 is supplied with an ink 315 from an ink supplying unit 313 while rotating, and the surface of the elastic mold 311 is coated with the ink 315. If the surface of the elastic mold 311 is coated with the ink 315, the ink 315 is firstly applied to the entire surface of the elastic mold 311 uniformly by means of an ink flattening unit 314, and the ink 315 applied to the embossed portion of the surface of the elastic mold 311 is removed by means of an ink removing belt 321 that rotates by a belt rotating unit 323.

### MODE FOR THE INVENTION

Hereinafter, the present invention is explained in more detail based on embodiments. However, the embodiments of the present invention may be modified in various ways, and it should be not interpreted that the scope of the present invention is limited to the following embodiments. The embodiments are provided just for better understanding of the present invention to those having ordinary skill in the art.

Printing of Fine Pattern

### Embodiment 1

A pattern surface of an elastic mold having PDMS as a main component was barcoated with a polymer resin solution having a surface energy of 29 to 30 erg/cm² by using a Meyer bar No. 5. The polymer resin solution includes carbon black, an acrylic binder, a dispersing agent and a surfactant, and a solvent contains propyleneglycol monomethyl ether as a main component. After that, a polypropylene roll having a surface energy of 31.9 ergs/cm² was rolled on the surface of the elastic mold coated with the polymer resin solution, thereby removing a polymer resin on a surface of a relatively protruded embossed portion of the elastic mold by means of the surface of the polypropylene roll. In this way, the polymer resin was selectively filled in an intagliated portion of the elastic mold. After that, the elastic mold was closely adhered to a PET substrate, and then, after a weak pressure is applied thereto, the elastic mold was taken away from the PET substrate such that a fine pattern of polymer rein was formed on the PET substrate.

### Embodiment 2

A pattern surface of an elastic mold having PDMS as a main component was barcoated with a polymer resin solution having a surface energy of 29 to 30 ergs/cm² by using a Meyer bar No. 5. After that, a polypropylene sheet having a surface energy of 31.9 ergs/cm² was rolled on the surface of the elastic mold coated with the polymer resin solution, thereby taking off a polymer resin on a surface of a relatively protruded embossed portion of the elastic mold by means of the surface of the polypropylene sheet. In this way, the polymer resin was selectively filled in an intagliated portion of the elastic mold. After that, the elastic mold was closely adhered to a glass substrate, and then, after a weak pressure is applied thereto, the elastic mold was taken away from the glass substrate such that a fine pattern of polymer rein was formed on the glass substrate.

### Embodiment 3

A pattern surface of an elastic mold having PDMS as a main component was barcoated with a polymer resin solution having a surface energy of 25.8 ergs/cm² by using a Meyer bar No. 5. After that, poly(butyl methacrylate) having a surface energy of 31 ergs/cm² was applied to a surface of a PET sheet to make a poly(butyl methacrylate) film, and the poly(butyl methacrylate) film was rolled on the surface of the elastic mold coated with the polymer resin solution, thereby taking off a polymer resin on a surface of a relatively protruded embossed portion of the elastic mold by means of the surface of the poly(butyl methacrylate) film. In this way, the polymer resin was selectively filled in an intagliated portion of the elastic mold. After that, the elastic mold was closely adhered to a glass substrate, and then, after a weak pressure is applied thereto, the elastic mold was taken away from the glass substrate such that a fine pattern of polymer rein was formed on the glass substrate.

### Comparative Examples 1 and 2

A fine pattern was formed in the same way as the embodiment 2, except that a PET sheet (the comparative example 1) having a surface energy of 46.7 ergs/cm² and a PDMS sheet (the comparative example 2) having a surface energy of 18 to 20 ergs/cm² were used instead of the polypropylene sheet.

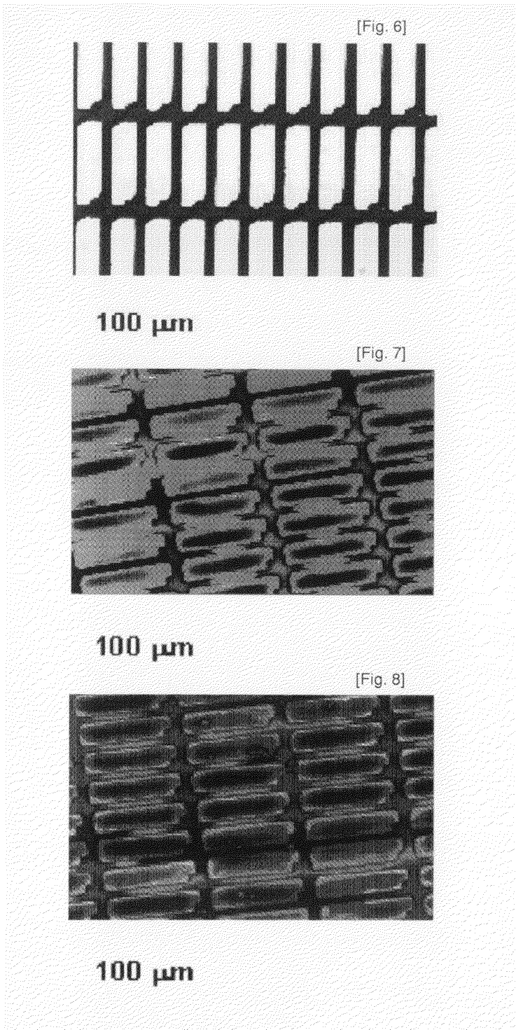

FIGS. 4 to 8 are photographs showing fine patterns according to the embodiments 1 to 3 and the comparative examples 1 and 2, respectively. In the fine patterns according to the embodiments 1 to 3 of the present invention (see FIGS. 4 to 6), it would be found that residuals on the embossed portion of the printing roller are completely removed, so the polymer resin solution in the intagliated portion is clearly printed. However, in the fine patterns according to the comparative examples 1 and 2 (see FIGS. 7 and 8), it would be understood that residuals on the embossed portion are printed, so the fine patterns are irregularly unclearly formed.

It should be understood that the terms used in the specification and appended claims should not be construed as being limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the spirit and scope of the invention.

### INDUSTRIAL APPLICABILITY

According to the method and system of printing fine patterns of the present invention, since an ink removing unit composed of a polymer resin with a surface energy similar to that of the ink is used during a gravure process for forming a fine pattern, the ink applied to an embossed portion of the printing roller may be effectively removed during the gravure process. In addition, particularly during a gravure process using an elastic mold, it is possible to remove only an ink applied to the embossed portion without removing an ink filled in an intagliated portion, thereby allowing formation of a fine pattern with good quality.

1. A method of printing fine patterns, which prints a fine pattern on a substrate using an elastic mold with an intaglio pattern, the method comprising:
applying a fine pattern printing ink to a surface of a patterned elastic mold;
removing the ink applied to an embossed portion of the elastic mold by closely adhering an ink removing unit having a polymer resin or an organic compound with a surface energy ranging from <a surface energy of the ink−2 erg/cm²> to <the surface energy of the ink+8 erg/cm²> to the surface of the elastic mold coated with the printing ink and then detaching the ink removing unit from the surface of the elastic mold; and
closely adhering the elastic mold to a substrate to transcribe the printing ink to the substrate.

2. The method of printing fine patterns according to claim 1,
wherein the ink has a surface energy ranging from 20 to 45 erg/cm².

3. The method of printing fine patterns according to claim 1,
wherein the elastic mold having the intaglio pattern is made of an elastomer with elasticity.

4. A printing system of fine patterns, comprising:
a printing roller having an outer circumference with an intaglio pattern and coating a substrate with a fine pattern printing ink filled in an intagliated portion of the outer circumference while rotating on a central axis;
an ink supplying unit for supplying and applying the ink to the outer circumference of the printing roller;
an ink removing belt rotating in close contact with an embossed portion of the outer circumference of the printing roller so as to remove an ink applied to the embossed portion of the outer circumference of the printing roller and having a polymer resin or an organic compound with a surface energy ranging from <a surface energy of the ink−2 erg/cm²> to <the surface energy of the ink+8 erg/cm²; and
a belt rotating unit for successively rotating the ink removing belt.

5. The printing system of fine patterns according to claim 4,
wherein the ink has a surface energy ranging from 20 to 45 erg/cm².

6. The printing system of fine patterns according to claim 4, wherein the printing roller includes:
a body; and
an elastic mold fixed to an outer circumference of the body and having an intaglio pattern.

7. The printing system of fine patterns according to claim 4, further comprising a holding roller,
wherein the holding roller is spaced apart from the printing roller such that a film-type substrate is held and carried between the holding roller and the printing roller.

8. The printing system of fine patterns according to claim 4, further comprising a drying device for drying the ink applied onto the substrate.

9. A printing system of fine patterns, comprising:
a printing roller having an outer circumference with an intaglio pattern and coating a substrate with a fine pattern printing ink filled in an intagliated portion while rotating on a central axis;
an ink supplying unit for supplying and applying the ink to the outer circumference of the printing roller; and
an ink removing roller rotating in close contact with an embossed portion of the outer circumference of the printing roller so as to remove an ink applied to the embossed portion of the outer circumference of the printing roller and having a polymer resin or an organic compound with a surface energy ranging from <a surface energy of the ink−2 erg/cm²> to <the surface energy of the ink+8 erg/cm²>.

10. The printing system of fine patterns according to claim 9,
wherein the ink has a surface energy ranging from 20 to 45 erg/cm².

11. The printing system of fine patterns according to claim 9, wherein the printing roller includes:
a body; and
an elastic mold fixed to an outer circumference of the body and having an intaglio pattern.

12. The printing system of fine patterns according to claim 9, further comprising a holding roller,
wherein the holding roller is spaced apart from the printing roller such that a film-type substrate is held and carried between the holding roller and the printing roller.

13. The printing system of fine patterns according to claim 9, further comprising a drying device for drying the ink applied on the substrate.
